(19) United States
(12) Patent Application Publication
(10) Pub. No.: US 2004/0044599 A1
(43) Pub. Date: Mar. 4, 2004

(54) Payment auditing

(75) Inventors: Scott J. Kepner, Sayre, PA (US); Wilson M. Tarbert, Endicott, NY (US); Sandra L. Yarosh, Great Bend, PA (US)

Correspondence Address: John R. Pivnichny, LLC, Patent Agent, 3824 Pembrooke Lane, Vestal, NY, 13827, US

(73) Assignee: International Business Machines Corporation, Armonk, NY

(21) Appl. No.: 10/230,043

(22) Filed: Aug. 27, 2002

(51) Int. Cl. G06F 17/60

(52) U.S. Cl. 705/30

(57) ABSTRACT

Taxes withheld from employees wages are sent to an outsourcing payroll company for subsequent remittance to many taxing authorities according to various filing frequency requirements. Various groups of employees may be paid on differing pay schedules such as weekly, bimonthly, or monthly. The outsourcing company earns interest on the funds for the period held and periodically returns a payment of the interest which is then audited by the employing company. In case of an underpayment, a bill may be sent to the outsourcing company for the underpayment.

### TECHNICAL FIELD

The invention relates generally to a method and system for auditing an interest payment received from a payroll outsourcing company. More particularly the invention relates to auditing the interest owed by an outsourcing company on payroll tax deductions received prior to submission to taxing authorities.

### BACKGROUND OF THE INVENTION

In order to improve productivity, companies may outsource payroll activities to a separate company. One such activity is the remittance of employees' income or wage tax withholdings to various taxing authorities such as the United States Internal Revenue Service, individual state income tax departments and other local taxing authorities. A large company for example may have employees or their payroll who are subject to several hundred different taxing jurisdictions. Furthermore, different employees may have different scheduled paydays depending on various factors such as local custom, job title, local or state labor laws or any other reasons. A large company may have several hundred different payday schedules. The sheer complexity of withholding taxes from employees pay and then remitting the withheld amounts to taxing authorities makes this activity an attractive one to outsource to a company with specific expertise in handling this high level of complexity.

Because of differences between paydays when taxes are withheld and due dates when withheld tax moneys must be remitted, withheld funds can be temporarily invested or deposited in an interest bearing account. When a company outsources this payroll activity the outsourcing company is expected to return some or all of the interest earned to the first company as determined by the outsourcing agreement between the two companies.

Other types of business transaction may have some similarities to this interest bearing model. For example, Nilssen in U.S. Pat. No. 5,083,782 describes paying interest on monetary equivalent certificates such as traveler's checks. The issuing of monetary equivalent certificates is highly profitable for the issuing entity because certificates remain un-redeemed on the average for a period of time during which interest income may be earned on their money value. In this case, however the issuing agency does not usually know or control the date on which an individual certificate will be redeemed.

Pickering, in U.S. Pat. Nos. 5,483,445 and 5,684,965 describes a credit card type of system in which a customer receives e.g. monthly a single consolidated bill for purchases made during the previous month from a variety of companies on various dates. The central processing office receives a single payment from the customer and then remits payment to all of the companies. With this system some of the companies may receive payment later than they otherwise would if they billed the customer directly themselves. Because of this delay, the companies lose monetary interest for the time of the delay. The central processing facility, therefore may make a payment to the companies to at least partly compensate for interest lost.

Francisco et al. in U.S. Pat. Nos. 5,799,283, 5,875,433, and 6,078,899 describe a sales tax reporting and collection system operating at a retailer location. When a customer purchases an item from the retailer, a system at the point-of-sale calculates the amount of sales tax owed from the customer and automatically forwards the amount of sales tax paid by the customer, to, for example, a state sales tax office computer. The taxing office is therefore ensured that all retail transactions and the sales taxes collected thereon are automatically reported, reducing losses which otherwise occur due to retailers not reporting all (e.g. cash) transactions.

Cretzler, in U.S. Pat. No. 5,644,724 also describes a point-of-sale sales tax collection system. A group of point-of-sale terminals receive and store sales tax collection information from the daily sum of collected taxes. For cash transactions, a bank computer receives the tax collection information. For credit or debit card transactions, a computer at the customer's bank receives the tax collection information. A tax authority bank receives and processes funds from both the bank computer and the customer's bank computer. Funds are therefore quickly and efficiently transferred to the taxing authority when due, minimizing loss of interest, due to delays in the payment process.

Golden et al. in U.S. Pat. No. 5,774,872 describe a similar sales tax system in which a central computer periodically interrogates each transaction terminal regarding transactions which have occurred during a period of time. In one embodiment, due to the large number of transaction terminals, data collection sub-stations are interposed between each transaction terminal and the central computer. Each sub-station is directed by the central computer to contact a particular transaction terminal, gather data concerning sales totals and collected tax, and then relay this information to the central computer.

Despite the above advancements in monetary certificates, credit cards, and sales tax collections, no satisfactory solution has been put forth for auditing the complex problem presented above for interest payments by payroll outsourcing activities. Devising such a solution is not a simple task. It is therefore believed that providing such an auditing solution would constitute a significant advancement in the payroll art.

### OBJECTS AND SUMMARY OF THE INVENTION

It is therefore a principal object of the present invention to provide a method of auditing such a payment.

It is another object to provide a method of auditing with enhanced operational capability.

It is yet another object to provide a system capable of auditing such a payment.

It is a further object to provide a computer program product for instructing a processor to audit such payment.

These and other objects are attained in accordance with one embodiment of the invention wherein there is provided a method of auditing a payment, comprising the steps of, entering a first sequence of payments made to a first party on a series of first dates, entering a plurality of second sequences of payments due to be made by the first party on a corresponding plurality of second dates to a corresponding plurality of second parties, entering an interest rate amount for all dates within the first and second sequences, computing an interest amount earned on the first sequence of payments held by the first party for a pre-specified time period, and comparing the computed interest amount, with a third payment received from the first party.

In accordance with another embodiment of the invention there is provided a system for auditing a payment, comprising, a processor, means for entering a first sequence of payments made to a first party on a series of first dates, into the processor, means for entering into the processor, a plurality of second sequences of payments due to be made by the first party on a corresponding plurality of second dates to a corresponding plurality of second parties, means for entering into the processor, an interest rate amount for all dates within the first and second sequences, software operable on the processor for computing an interest amount earned on the first sequence of payments held by the first party for a pre-specified time period, and means for comparing the computed interest amount, with a third payment received from the first party.

In accordance with yet another embodiment of the invention there is provided a computer program product for instructing a processor to audit a payment, the computer program product comprising a computer readable medium, first program instruction means for entering a first sequence of payments made to a first party on a series of first dates, second program instruction means for entering a plurality of second sequences of payments due to be made by the first party on a corresponding plurality of second dates to a corresponding plurality of second parties, third program instruction means for entering an interest rate amount for all dates within the first and second sequences, fourth program instruction means for computing an interest amount earned on the first sequence of payments held by the first party for a pre-specified time period, and fifth program instruction means for comparing the computed interest amount, with a third payment received from the first party, and wherein all the program instruction means are recorded on the medium.

### BRIEF DESCRIPTION OF THE DRAWINGS

FIG. 1 is a flowchart illustrating a method of auditing a payment;

FIG. 2 illustrates a system for auditing a payment; and

FIG. 3 is a logic diagram for computing interest earned.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

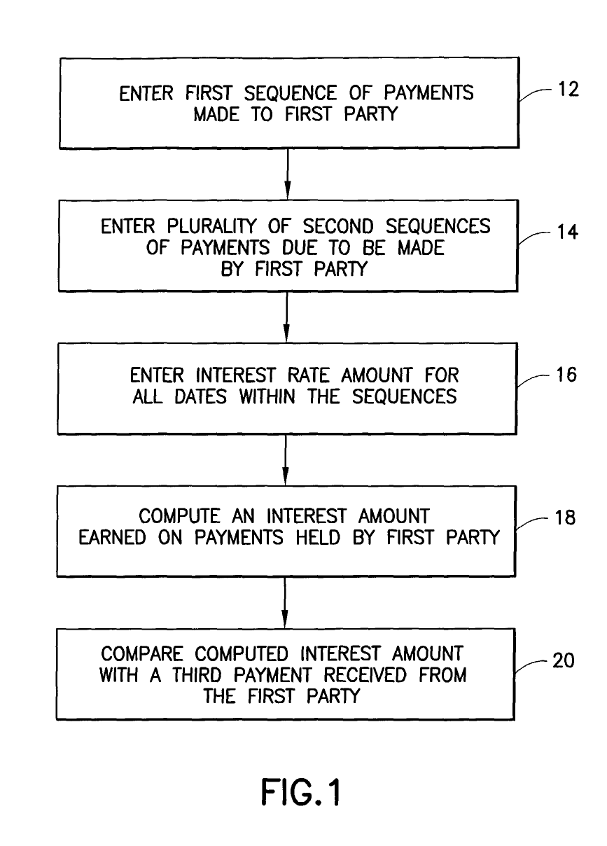

In FIG. 1 there is shown a flowchart of steps of a method of auditing a payment in accordance with the present invention. In step 12 a first sequence of payments made to a first party on a series of first dates are entered into a computing system. The sequence of payments represent taxes withheld from employees' wages on a series of payroll dates. For example, if employees are paid every week on Thursday, then the sequence of payments may be the total amounts of federal income tax withheld from the employees on each of the paydates in a certain month, or certain quarter of a year, or over any other period of time. The first sequence of payments may also include the total amounts of state and local income or wage tax withheld from the employees wages on each of the paydates for each of these taxing authorities. Furthermore, the first sequence may also include amounts withheld from additional groups of employees who are paid on different payroll dates, such as monthly, bimonthly, weekly on some other day, or any to the paydates.

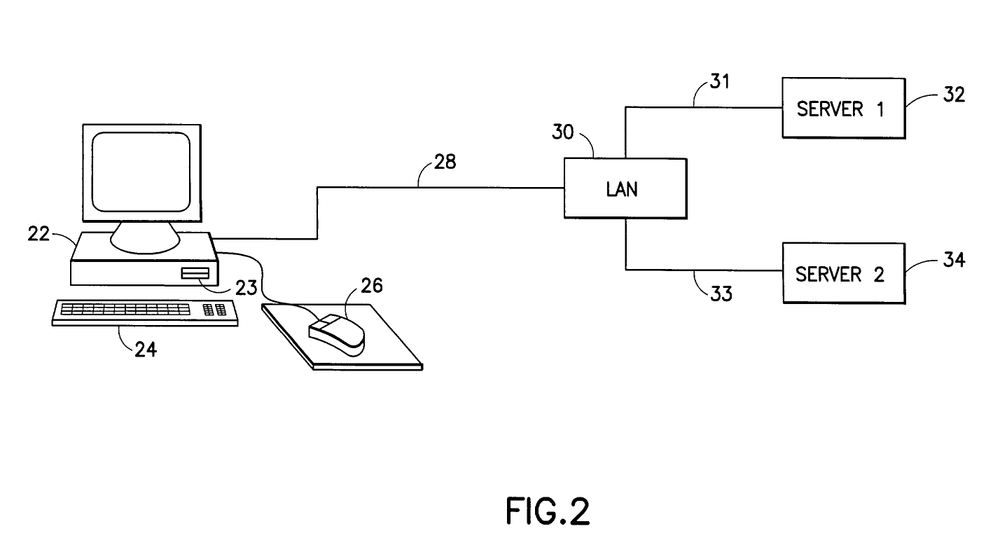

The sequence of payments are made to a first party who is normally a payroll outsourcing company or service. The payments are made to the first party on the paydates on which the employees are paid or shortly before or thereafter. Records listing the sequence of payments made may be entered into a computing system such as system 22 of FIG. 2 by initiating a query over network 30 to a database on a payroll server 32 where the actual payroll and withholding amounts are stored for each employee for each paydate. Query results are returned over the network 30 and entered into system 22. Other methods of entering data such as those described below may also be used.

In step 14 a plurality of second sequences of payments due to be made by the first party on a corresponding plurality of second dates to a corresponding plurality of second parties is entered into the computing system. The second parties are the taxing authorities to which the outsourcing company must remit the withheld tax amounts which they received on the first series of dates and are temporarily holding. The second dates are the due dates for remitting the withheld amounts. As noted above, each taxing authority decides when withheld taxes are due, sometimes referred to as the filing frequency or deposit date. For example, Table 1 below shows nineteen different filing frequencies currently in use by the several hundred taxing authorities, along with a filing frequency code used in one embodiment of the present invention.

TABLE 1

| CODE | FILING FREQUENCY |
|---|---|
| AN | Annually |
| AM | Accelerated Monthly |
| AQ | Accelerated Quarterly |
| D1 | Daily |
| D3 | 3 Day Due Daily |
| D5 | 5 Day Due Daily |
| FF | Same as Federal Frequency |
| LD | Limit Driven |
| MN | Monthly |
| oM | Octal Monthly |
| QM | Quarter Monthly |
| QT | Quarterly |
| SA | Semi-Annually |
| SM | Semi-Monthly |
| SW | Semi-Weekly |
| T1 | Tied to Fed (with a |
| | different daily) |
| T2 | Tied to Fed (daily only) |
| TF | Tied to Fed |
| WK | Weekly |

For example, the plurality of second sequences may be for a certain period of time such as a month, quarter, year or any other specified period.

Because of the large number of taxing authorities, who may change their filing requirements at any time, frequent changes must be made in determining the actual dates on which the plurality of second sequence of payments are due to be made. The outsourcing company is usually expected to also keep track of these changing requirements in order to insure the plurality of second sequences of payments are made when due. Making payments earlier than due is undesirable because of the lost interest which could have been earned on the held funds. Late payments are also undesirable because of late fees which are usually larger than any additional interest gained by late payments. The outsourcing company is usually expected to bear the burden of either early or late payment. Consequently, in step 14 the payment amounts are entered for the dates when due, regardless of when the outsourcing company actually makes or made the payments.

The sequences in step 14 are entered using any of the techniques used in step 12.

In step 16 an interest rate amount or percentage is entered into the computer system. The interest rate is applicable for the specific period of time e.g. monthly, quarterly, noted above. For example, a daily interest rate may be entered for each day in the specific period of time. During times of stable interest rates, a single value may apply for the entire period of time. The interest rate may be set by an agreement or contract with the outsourcing company and may also be derived from a published or set rate such as the average of the 3-Month federal funds rate published by the United States Treasury Department. The interest rate may be entered manually, or by any other method including querying the Treasury Department website to obtain the published rates.

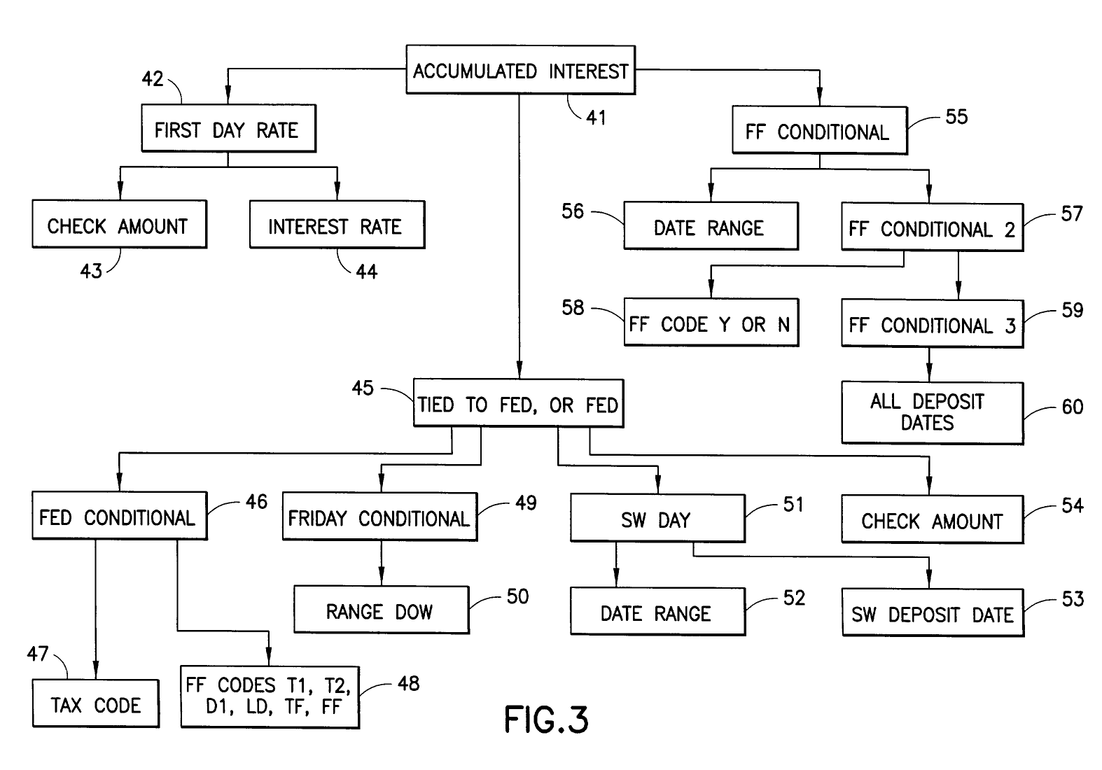

In step 18 an interest amount earned on the funds held by the first party is computed for a pre-specified time period. The time period may be a week, a month, a quarter, a day, or any other time period. One such method of computing shown in FIG. 3 is described in detail below.

In step 20 the interest amount computed in step 18 is compared to a third payment from the first party. This third payment is the interest amount received from the outsourcing company for the funds held during the certain period. If the interest amount computed in step 18 is larger, then the outsourcing company has underpaid and may be billed for an underpayment.

In FIG. 2 there is shown a system for auditing a payment in accordance with the present invention. Computing system or processor 22 may have a keyboard 24 and mouse 26 attached for use as entry devices. Other entry devices, not shown, known in the art may also be attached. Computing system 22 may be any type of processing device including a laptop, desktop, tower, palm device, portable, cellphone, mainframe, server or any other type of computer processing device. Processor 22 may be adapted 23 for receiving recorded or recordable media such as floppy disk, compact disk (CD), digital video disk (DVD), zip disk, or tape. Processor 22 may also be attached 28 to a network 30 via any type of network connection including a local area network (LAN), wide area network (WAN), dial up connection, wireless, infrared, or radio frequency connection. One or more servers 32, 34 may also be connected via 31 and 33 respectfully to network 30.

Processor 22 has means for reentering a first sequence of payments made to a first party on a series of first dates. The first dates may be payroll dates. For example, entering data or a file into a memory device within processor 22 may be one way of entering the sequence. A user may enter the sequence by causing data or a file on a remote server 32 or 34 to be transferred over network 30 into processor 22 by means of a query into a database located on the remote server. The database may be a relational database, a spreadsheet, or any other type of database. The first sequence may also be entered manually using input devices such as keyboard 24 or 26 or by inserting a recordable media having the first sequence recorded thereon into media adapter 23. The means for entering may also include software functions installed on processor 22 or software/hardware combinations.

Processor 22 also has similar means for entering a plurality of second sequences of payments due to be made by the first party on a corresponding plurality of second dates to a corresponding plurality of second parties. The plurality of second sequences may also be data or a file located on a remote server such as 32 or 34. The second sequences may be payments due to a plurality of taxing authorities including states of the United States of America.

Processor 22 also has similar means for entering an interest rate amount or percentage for all dates within the first and plurality of second sequences.

Software operating on processor 22 is capable of computing an interest amount earned on the fist sequence of payments held by the first party for a pre-specified time period. Any type of software may be used including LOTUS APPROACH™ (LOTUS APPROACH is a trademark of Lotus Development Corp., Cambridge, Mass.), spreadsheet software, VISUAL BASIC® (VISUAL BASIC is a registered trademark of Microsoft Corp., Redmond, Wash.) C++ or any other type of software known in the art. The software computes an interest amount based on the entered rate and first and plurality of second sequences of payments for a particular time period. One way of computing the interest amount is described below in conjunction with the logic diagram of FIG. 3.

Processor 22 also has means for comparing the computed interest amount with a third payment received from the first party. Such means may include a software or hardware or combination comparison of amounts. If there is an underpayment, processor 22 has means for billing the first party for any such underpayment. Means for billing may include printing an invoice or bill which is then mailed to the third party. Other means may include sending an electronic bill such as via e-mail, or via the Internet, or via any electronic billing system.

In FIG. 3 there is shown a logic diagram for computing interest earned in accordance with the present invention. The logic depicted in FIG. 3 may be entered as statements or code into a database such as LOTUS APPROACH where various fields will be operated on to produce an accumulated interest result 41. Focusing presently on a single first payment date or payday, a file containing the summed up amounts by taxing jurisdiction withheld from all employees paid on that day is entered. For example, a user may run a query to a server. The results may optionally first be put into a spreadsheet for editing and formatting. The spreadsheet data is then entered into a LOTUS APPROACH database such as by use of a copy and paste capability. Running the database software on processor 22 causes the logic of FIG. 3 to calculate the accumulated interest for each taxing jurisdiction and each payday over a specified time period.

For example, box 45 determines whether the taxing jurisdiction is the federal government or has its filing frequency tied to the federal government. If so then box 46 via box 48 determines whether the filing frequency is code T1, T2, D1, LD, TF, FF (see Table 1 above) or whether some other tax code applies in box 47. If the payday is a Friday, then the funds may be filed on Monday giving two extra days interest in box 49 and day of week box 50. If the total check amount 54 withheld is less then $100,000 (at present) then the funds may be held longer and paid semi-weekly in box 51 based on the date range 52 and semi-weekly deposit dates 53.

For taxing jurisdictions not tied to the federal government, logic boxes 55-60 determine the actual required filing date based on file frequency code 57, 58, 59, date range 56, and all deposit dates 60, as specified by the tax code of each jurisdiction.

Interest on funds held for a particular jurisdiction is then computed 42 for the first day based on the amount of funds withheld 43 and interest rate 44 for that day. Iteration of these steps for each day until the funds must be paid provides the accumulated interest 41 result for that payday and jurisdiction. Additional iterations for all jurisdictions and all paydays within the pre-specified time period produces the total computed interest amount earned on the funds held during that time period.

The logic of FIG. 3 serves as one example of computing the interest earned, and is not intended to be limiting. Other variations in logic producing equivalent results will be obvious to those of ordinary skill.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of auditing a payment, comprising the steps of:
entering a first sequence of payments made to a first party on a series of first dates;
entering a plurality of second sequences of payments due to be made by said first party on a corresponding plurality of second dates to a corresponding plurality of second parties;
entering an interest rate amount for all dates within said first and second sequences;
computing an interest amount earned on said first sequence of payments held by said first party for a pre-specified time period; and
comparing the computed interest amount, with a third payment received from said first party.

2. The method of claim 1, wherein said first dates are payroll dates for employees in a company.

3. The method of claim 1, wherein said plurality of second sequences of payments due, are payments due to a plurality of taxing authorities.

4. The method of claim 3, wherein said taxing authorities comprise states of the United States of America.

5. The method of claim 1, wherein said interest rate amount is entered as an actual daily interest rate for each day within said first and second sequences.

6. The method of claim 1, wherein said computing is performed by database software.

7. The method of claim 1, further comprising the step of billing said first party for an underpayment amount in said third payment.

8. A system for auditing a payment, comprising:
a processor;
means for entering a first sequence of payments made to a first party on a series of first dates, into said processor;
means for entering into said processor, a plurality of second sequences of payments due to be made by said first party on a corresponding plurality of second dates to a corresponding plurality of second parties;
means for entering into said processor, an interest rate amount for all dates within said first and second sequences;
software operable on said processor for computing an interest amount earned on said first sequence of payments held by said first party for a pre-specified time period; and
means for comparing the computed interest amount, with a third payment received from said first party.

9. The system of claim 8, wherein said first dates are payroll dates for employees in a company.

10. The system of claim 8, wherein said plurality of second sequences of payments due, are payments due to a plurality of taxing authorities.

11. The system of claim 10, wherein said taxing authorities comprise states of the United States of America.

12. The system of claim 8, wherein said interest rate amount is entered as an actual daily interest rate for each day within said first and second sequences.

13. The system of claim 8, wherein said software for computing an interest amount comprises database software code.

14. The system of claim 8, further comprising means for billing said first party for an underpayment amount in said third payment.

15. A computer program product for instructing a processor to audit a payment, said computer program product comprising:
a computer readable medium;
first program instruction means for entering a first sequence of payments made to a first party on a series of first dates;
second program instruction means for entering a plurality of second sequences of payments due to be made by said first party on a corresponding plurality of second dates to a corresponding plurality of second parties;
third program instruction means for entering an interest rate amount for all dates within said first and second sequences;
fourth program instruction means for computing an interest amount earned on said first sequence of payments held by said first party for a pre-specified time period; and
fifth program instruction means for comparing the computed interest amount, with a third payment received from said first party; and wherein
all said program instruction means are recorded on said medium.

16. The computer program product of claim 15, wherein said first dates are payroll dates for employees in a company.

17. The computer program product of claim 15, wherein said plurality of second sequences of payments due, are payments due to a plurality of taxing authorities.

18. The computer program product of claim 17, wherein said taxing authorities comprise states of the United States of America.

19. The computer program product of claim 15, wherein said interest rate amount is entered as an actual daily interest rate for each day within said first and second sequences.

20. The computer program product of claim 15, further comprising sixth program instruction means for billing said first party for an underpayment amount in said third payment.
